(19) United States
(12) Patent Application Publication
(10) Pub. No.: US 2025/0308448 A1
(43) Pub. Date: Oct. 2, 2025

(54) SUB-PIXEL, DISPLAY DEVICE INCLUDING THE SUB-PIXEL, AND DISPLAY SYSTEM INCLUDING THE DISPLAY DEVICE

(71) Applicant: Samsung Display Co., LTD., Yongin-si (KR)

(72) Inventor: Sang Yong NO, Yongin-si (KR)

(21) Appl. No.: 19/011,810

(22) Filed: Jan. 7, 2025

(30) Foreign Application Priority Data
Mar. 29, 2024 (KR) 10-2024-0043179

(51) Int. Cl. G09G 3/3233; G09G 3/20

(52) U.S. Cl. CPC G09G 3/3233; G09G 3/2007; G09G 2300/0465; G09G 2300/0819; G09G 2300/0842; G09G 2310/08; G09G 2320/0233

(57) ABSTRACT

A sub-pixel includes a first transistor connected between a first node and a second node and including a gate electrode connected to a third node, a second transistor connected between a data line and the third node and including a gate electrode connected to a first sub-gate line, a third transistor connected between the first node and a first power source voltage node configured to supply a first power source voltage and including a gate electrode connected to an emission control line, and a light emitting element connected between the second node and a second power source voltage node configured to supply a second power source voltage lower than the first power source voltage. Body electrodes of the first transistor through the third transistor are biased with at least one voltage. The sub-pixel further includes a capacitor connected between the first node and the third node.

This application claims priority to Korean Patent Application No. 10-2024-0043179, filed on Mar. 29, 2024, and all the benefits accruing therefrom under 35 U.S.C. § 119, the content of which in its entirety is herein incorporated by reference.

### BACKGROUND

### Field

Embodiments supported by the present disclosure relates to an electronic device, and more specifically, to a sub-pixel, a display device including the sub-pixel, and a display system including the display device.

### Description of the Related Art

As information technology develops, the importance of a display device as a connection medium between a user and information is being emphasized. In response to this, the use of display devices such as, for example, a liquid crystal display device and an organic light emitting display device is increasing.

Recently, a head-mounted display device (HMD) has been developed. The head-mounted display device is a display device worn by a user in the form of glasses or a helmet and implements virtual reality (VR) or augmented reality (AR) that is focused close to the eyes. A high-resolution panel is applied to the head-mounted display device, and accordingly, sub-pixels applicable to the high-resolution panel may be required.

The above description is for helping the understanding of the background art for the technical ideas of the present invention. Therefore, it should not be understood as the contents corresponding to the prior art known to those skilled in the art to which the present invention pertains.

### SUMMARY

Embodiments of the present invention provide a display device including high-resolution sub-pixels.

Embodiments of the present invention provide a display device including sub-pixels that can be manufactured at reduced cost.

A sub-pixel included in a display device according to an embodiment supported by the present disclosure may include a first transistor connected between a first node and a second node and including a gate electrode connected to a third node; a second transistor connected between a data line and the third node and including a gate electrode connected to a first sub-gate line; a third transistor connected between the first node and a first power source voltage node configured to supply a first power source voltage and including a gate electrode connected to an emission control line; and a light emitting element connected between the second node and a second power source voltage node configured to supply a second power source voltage lower than the first power source voltage. Body electrodes of the first transistor through the third transistor are biased with at least one voltage. The sub-pixel further includes a capacitor connected between the first node and the third node, without a capacitor connected to the second node and the third node.

The first power source voltage may be applied to the body electrode of the first transistor.

The sub-pixel may not include any capacitors other than the capacitor.

The sub-pixel may further include a fourth transistor connected between the second node and an initialization voltage node configured to supply an initialization voltage and including a gate electrode connected to a second sub-gate line.

The first power source voltage may be commonly applied to the body electrodes of the first transistor through the third transistor and a body electrode of the fourth transistor.

Each of the first transistor through the fourth transistor may be a PMOS (P-channel Metal Oxide Semiconductor) transistor.

The first transistor through the fourth transistor may be mounted on a silicon substrate.

The initialization voltage may be equal to or lower than the second power source voltage.

Another aspect of the present invention relates to a display device. A display device according to an embodiment supported by the present disclosure may include sub-pixels connected to gate lines and emission control lines; and a gate driver configured to control the gate lines and the emission control lines. A sub-pixel of the sub-pixels may include a first transistor connected between a first node and a second node and including a gate electrode connected to a third node; a second transistor connected between a data line and the third node and including a gate electrode connected to a first sub-gate line of one of the gate lines; a third transistor connected between the first node and a first power source voltage node configured to supply a first power source voltage and including a gate electrode connected to one of the emission control lines; and a light emitting element connected between the second node and a second power source voltage node configured to supply a second power source voltage lower than the first power source voltage. Body electrodes of the first transistor through the third transistor are biased with at least one voltage. The sub-pixel further includes a capacitor connected between the first node and the third node, without a capacitor connected to the second node and the third node.

The first power source voltage may be applied to the body electrode of the first transistor.

The sub-pixel may not include any capacitors other than the capacitor.

The sub-pixel may further include a fourth transistor connected between the second node and an initialization voltage node configured to supply an initialization voltage and including a gate electrode connected to a second sub-gate line of the one of the gate lines.

The first power source voltage may be commonly applied to the body electrodes of the first transistor through the third transistor and a body electrode of the fourth transistor.

The gate driver may be configured to: turn on the fourth transistor by supplying a second scan signal set to logic low level to the second sub-gate line during a first period, a second period, and a third period provided sequentially, turn on the second transistor by supplying a first scan signal set to logic low level to the first sub-gate line and to turn off the third transistor by supplying an emission control signal set to logic high level to the one of the emission control lines, during the second period, turn off the second transistor by setting the first scan signal to logic high level during the third period, and turn off the fourth transistor by setting the second scan signal to logic high level and turn on the third transistor by setting the emission control signal to logic low level, during a fourth period.

The display device may further include a data driver configured to control the data line. The data driver may be configured to supply a data signal to the data line during the second period.

During the second period, the data signal of the data line may be reflected in a voltage of the third node through the second transistor. During the fourth period, current may be supplied from the first power source voltage node to the light emitting element through the third transistor and the first transistor according to the voltage of the third node.

Still another aspect of the present invention relates to a display system. The display system according to an embodiment supported by the present disclosure may include a processor; and at least one display device to display images on sub-pixels based on image data from the processor. One of the sub-pixels includes: a first transistor connected between a first node and a second node and including a gate electrode connected to a third node; a second transistor connected between a data line and the third node and including a gate electrode connected to a first sub-gate line; a third transistor connected between the first node and a first power source voltage node configured to supply a first power source voltage and including a gate electrode connected to an emission control line; and a light emitting element connected between the second node and a second power source voltage node configured to supply a second power source voltage lower than the first power source voltage. Body electrodes of the first transistor through the third transistor are biased with at least one voltage. The one of the sub-pixels further includes a capacitor connected between the first node and the third node, without a capacitor connected to the second node and the third node.

### BRIEF DESCRIPTION OF THE DRAWINGS

The accompanying drawings, which are included to provide a further understanding of the inventive concepts, and are incorporated in and constitute a part of this specification, illustrate example embodiments of the inventive concepts, and, together with the description, serve to explain principles of the inventive concepts.

FIG. 1 is a block diagram of a display device according to an embodiment supported by the present disclosure.

FIG. 2 is a block diagram illustrating an embodiment of a sub-pixel of FIG. 1.

FIG. 3 is a block diagram illustrating an embodiment of a display panel and a gate driver of FIG. 1.

FIG. 4 is a circuit diagram illustrating an embodiment of the sub-pixel of FIG. 2.

FIG. 5 is a timing diagram illustrating an embodiment of signals provided to the sub-pixel of FIG. 4 during a display operation.

FIGS. 6 to 9 are diagrams for explaining operations of the sub-pixel in first to fourth periods of FIG. 5.

FIG. 10 is a plan view illustrating an embodiment of the display panel of FIG. 1.

FIG. 11 is an exploded perspective view illustrating a portion of the display panel of FIG. 10.

FIG. 12 is a block diagram illustrating an embodiment of a display system.

FIG. 13 is a perspective view illustrating an application example of the display system of FIG. 12.

FIG. 14 is a diagram illustrating a head-mounted display device worn by a user.

### DETAILED DESCRIPTION

Hereinafter, example embodiments of the present invention will be described in more detail with reference to the accompanying drawings. It should be noted that in the following description, parts supportive of understanding the operation according to the present invention will be described, and descriptions of other parts will be omitted in order to not obscure the gist of the present invention. In some aspects, the present invention is not limited to the embodiments described herein and may be embodied in other forms. The embodiments described herein are provided merely to explain in detail enough to enable those skilled in the art to easily implement the technical idea of the present invention.

Throughout the specification, in a case where a portion is “connected” to another portion, the case includes not only a case where the portions are “directly connected” but also a case where the portions are “indirectly connected” with another element interposed between the portions. Terms used herein are for describing specific embodiments and are not intended to limit the present invention. Throughout the specification, in a case where a certain portion “includes”, the case means that the portion may further include another component without excluding another component unless otherwise stated. “At least any one of X, Y, and Z” and “at least any one selected from a group consisting of X, Y, and Z” may be interpreted as one X, one Y, one Z, or any combination of two or more of X, Y, and Z (for example, XYZ, XYY, YZ, and ZZ). Here, “and/or” includes all combinations of one or more of corresponding configurations.

Here, terms such as, for example, first and second may be used to describe various components, but these components are not limited to these terms. These terms are used to distinguish one component from another component. Therefore, a first component may refer to a second component within a range without departing from the scope disclosed herein.

Spatially relative terms such as, for example, “under”, “on”, and the like may be used for descriptive purposes, thereby describing the relationship between one element or feature and another element(s) or feature(s) as illustrated in the drawings. Spatially relative terms are intended to include other directions in use, in operation, and/or in manufacturing, in addition to the direction depicted in the drawings. For example, when a device illustrated in the drawing is turned upside down, elements depicted as being positioned “under” other elements or features are positioned in a direction “on” the other elements or features. Therefore, in an embodiment, the term “under” may include both directions of on and under. In some aspects, the device may face in other directions (for example, rotated 90 degrees or in other directions) and thus the spatially relative terms used herein are interpreted according thereto.

The term “substantially,” as used herein, means approximately or actually. The term “substantially equal” means approximately or actually equal. The term “substantially the same” means approximately or actually the same.

Various embodiments are described with reference to drawings schematically illustrating example embodiments. Accordingly, it will be expected that shapes may vary, for example, according to tolerances and/or manufacturing techniques. Therefore, the embodiments disclosed herein cannot be construed as being limited to illustrated specific shapes, and should be interpreted as including, for example, changes in shapes that occur as a result of manufacturing. As described herein, the shapes illustrated in the drawings may not show actual shapes of areas of a device, and the present embodiments are not limited thereto.

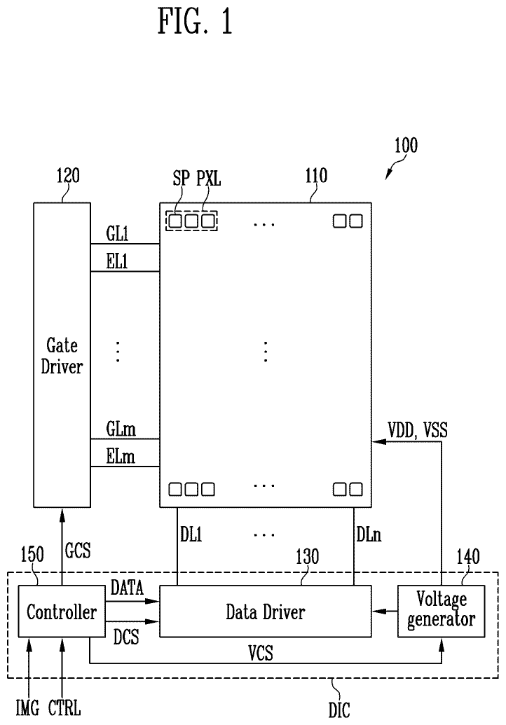

FIG. 1 is a block diagram of a display device according to an embodiment supported by the present disclosure.

Referring to FIG. 1, a display device 100 may include a display panel 110, a gate driver 120, a data driver 130, a voltage generator 140, and a controller 150.

The display panel 110 may include sub-pixels SP. The sub-pixels SP may be connected to the gate driver 120 through first gate line GL1 through m-th gate line GLm. The sub-pixels SP may be connected to the data driver 130 through first data line DL1 through n-th data line DLn.

Each of the sub-pixels SP may include at least one light emitting element configured to generate light. Accordingly, each of the sub-pixels SP may generate light of a specific color, such as red, green, blue, cyan, magenta, yellow, or the like. Two or more sub-pixels among the sub-pixels SP may constitute one pixel PXL. For example, as illustrated in FIG. 1, three sub-pixels may constitute one pixel PXL.

The gate driver 120 may be connected to sub-pixels SP arranged in a row direction through the first gate line GL1 through the m-th gate line GLm. The gate driver 120 may output scan signals to the first gate line GL1 through the m-th gate line GLm in response to a gate control signal GCS. In some embodiments, the gate control signal GCS may include a scan start signal indicating the start of each frame, a horizontal synchronization signal for outputting the scan signals in synchronization with the timing at which data signals are applied, and the like.

In some embodiments, first emission control line EL1 through m-th emission control line ELm connected to the sub-pixels SP in the row direction may be further provided. In this case, the gate driver 120 may include an emission driver configured to control the first emission control line EL1 through m-th emission control line ELm. The emission driver may operate under the control of the controller 150.

The gate driver 120 may be disposed on one side of the display panel 110. However, embodiments of the present invention are not limited thereto. For example, the gate driver 120 may be divided into two or more physically and/or logically separated drivers. These drivers may be disposed on one side of the display panel 110 and on the other side of the display panel 110 opposite to the one side. As such, the gate driver 120 may be disposed around the display panel 110 in various forms depending on embodiments.

The data driver 130 may be connected to sub-pixels SP arranged in a column direction through the first data line DL1 through n-th data line DLn. The data driver 130 may receive image data DATA and a data control signal DCS from the controller 150. The data driver 130 may operate in response to the data control signal DCS. In some embodiments, the data control signal DCS may include a source start pulse, a source shift clock, a source output enable signal, and the like.

The data driver 130 may apply data signals having grayscale voltages corresponding to the image data DATA to the first data line DL1 through n-th data line DLn using voltages from the voltage generator 140. In an example in which a scan signal is applied to each of the first gate line GL1 through the m-th gate line GLm, the data signals corresponding to the image data DATA may be applied to the data lines DL1 to DLn. Accordingly, corresponding sub-pixels SP may generate light corresponding to the data signals. Accordingly, an image may be displayed on the display panel 110.

In some embodiments, the gate driver 120 and the data driver 130 may include complementary metal-oxide semiconductor (CMOS) circuit elements.

The voltage generator 140 may operate in response to a voltage control signal VCS from the controller 150. The voltage generator 140 may be configured to generate a plurality of voltages and provide the generated voltages to components of the display device 100. For example, the voltage generator 140 may be configured to generate a plurality of voltages by receiving an input voltage from outside the display device 100, adjusting the received voltage, and regulating the adjusted voltage.

The voltage generator 140 may generate a first power source voltage VDD and a second power source voltage VSS, and provide the generated first and second power source voltages VDD and VSS to the sub-pixels SP. The first power source voltage VDD may have a relatively high voltage level, and the second power source voltage VSS may have a voltage level lower than the first power source voltage VDD. In other embodiments, the first power source voltage VDD or the second power source voltage VSS may be provided by a device external to the display device 100.

In some aspects, the voltage generator 140 may generate various voltages. For example, the voltage generator 140 may generate an initialization voltage applied to the sub-pixels SP. In some embodiments, the initialization voltage may have the same voltage level as the second power source voltage VSS. In other embodiments, the initialization voltage may have a voltage level between the first power source voltage VDD and the second power source voltage VSS. In still other embodiments, the initialization voltage may have a voltage level lower than the second power source voltage VSS.

The controller 150 may control various operations of the display device 100. The controller 150 may receive input image data IMG and a control signal CTRL for controlling its display from the outside. The controller 150 may provide the gate control signal GCS, the data control signal DCS, and the voltage control signal VCS in response to the control signal CTRL.

The controller 150 may convert the input image data IMG to suit the display device 100 or display panel 110, generate the image data DATA, and output the image data DATA to the data driver 130. In some embodiments, the controller 150 may output the image data DATA by rearranging the input image data IMG to fit the sub-pixels SP in row units.

Two or more components of the data driver 130, the voltage generator 140, and the controller 150 may be mounted on one integrated circuit. As illustrated in FIG. 1, the data driver 130, the voltage generator 140, and the controller 150 may be included in a driver integrated circuit DIC. In this case, the data driver 130, the voltage generator 140, and the controller 150 may be functionally separate components within one driver integrated circuit DIC. In other embodiments, at least one of the data driver 130, the voltage generator 140, and the controller 150 may be provided as a separate component from the driver integrated circuit DIC.

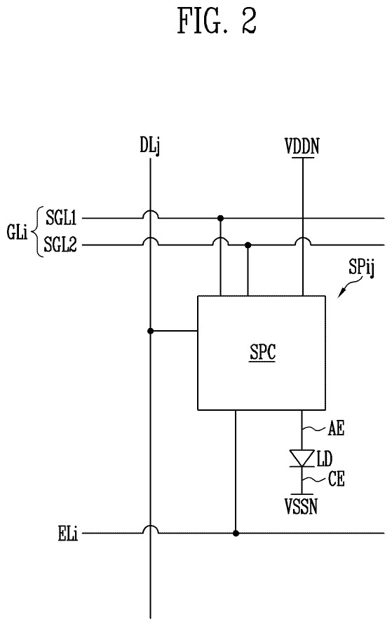

FIG. 2 is a block diagram illustrating an embodiment of a sub-pixel of FIG. 1.

In FIG. 2, among the sub-pixels SP of FIG. 1, a sub-pixel SPij arranged in an i-th row (i may be an integer greater than or equal to 1 and less than or equal to m) and a j-th column (j may be an integer greater than or equal to 1 and less than or equal to n) is illustrated as an example.

Referring to FIG. 2, the sub-pixel SPij may include a sub-pixel circuit SPC and a light emitting element LD.

The light emitting element LD may be connected between a first power source voltage node VDDN and a second power source voltage node VSSN. In this case, the first power source voltage node VDDN may be a node to which the first power source voltage VDD of FIG. 1 is applied, and the second power source voltage node VSSN may be a node to which the second power source voltage VSS of FIG. 1 is applied.

An anode electrode AE of the light emitting element LD may be connected to the first power source voltage node VDDN through the sub-pixel circuit SPC. A cathode electrode CE of the light emitting element LD may be connected to the second power source voltage node VSSN. For example, the anode electrode AE of the light emitting element LD may be connected to the first power source voltage node VDDN through one or more transistors included in the sub-pixel circuit SPC.

The sub-pixel circuit SPC may be connected to an i-th gate line GLi among the first gate line GL1 through the m-th gate line GLm of FIG. 1, an i-th emission control line Eli among the first emission control line EL1 through m-th emission control line ELm of FIG. 1, and a j-th data line DLj among the first data line DL1 through n-th data line DLn of FIG. 1. The sub-pixel circuit SPC may be configured to control the light emitting element LD according to signals received through these signal lines.

The sub-pixel circuit SPC may operate in response to a scan signal received through the i-th gate line GLi. The i-th gate line GLi may include first and second sub-gate lines SGL1 and SGL2. The sub-pixel circuit SPC may operate in response to scan signals received through the first and second sub-gate lines SGL1 and SGL2.

The sub-pixel circuit SPC may operate in response to an emission control signal received through the i-th emission control line ELi. The sub-pixel circuit SPC may operate in response to an emission control signal received through the i-th emission control line ELi.

The sub-pixel circuit SPC may receive a data signal through the j-th data line DLj. The sub-pixel circuit SPC may store a voltage corresponding to the data signal in response to at least one of the scan signals received through the first and second sub-gate lines SGL1 and SGL2. The sub-pixel circuit SPC may adjust the current flowing from the first power source voltage node VDDN to the second power source voltage node VSSN through the light emitting element LD according to the stored voltage in response to the emission control signal received through the i-th emission control line Eli. Accordingly, the light emitting element LD may generate light with a luminance corresponding to the data signal.

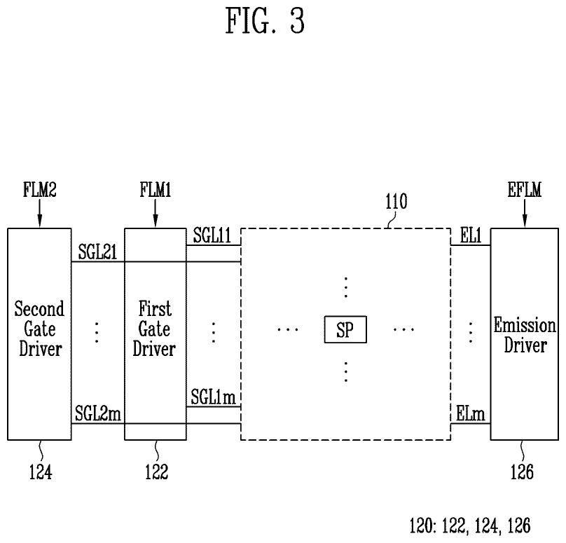

FIG. 3 is a block diagram illustrating an embodiment of a display panel and a gate driver of FIG. 1.

Referring to FIG. 3, the gate driver 120 may include a first gate driver 122, a second gate driver 124, and an emission driver 126.

The first gate driver 122 may receive a first scan start signal FLM1. The first gate driver 122 may generate a first scan signal while shifting the first scan start signal FLM1 in response to a clock signal. The first gate driver 122 may sequentially supply the first scan signal to first sub-gate lines SGL11 to SGL1m. Among the first sub-gate lines SGL11 to SGL1m, an i-th sub-gate line SGL1i may be the first sub-gate line SGL1 of the i-th gate line GLi of FIG. 2.

The second gate driver 124 may receive a second scan start signal FLM2. The second gate driver 124 may generate a second scan signal while shifting the second scan start signal FLM2 in response to a clock signal. The second gate driver 124 may sequentially supply the second scan signal to second sub-gate lines SGL21 to SGL2m. Among the second sub-gate lines SGL21 to SGL2m, an i-th sub-gate line SGL2i may be the second sub-gate line SGL2 of the i-th gate line GLi of FIG. 2.

The first scan signal may have a gate-on voltage such that transistors of sub-pixels SP receiving the first scan signal are turned on. In other words, supplying the first scan signal to a sub-gate line may mean that the gate-on voltage is supplied to the corresponding sub-gate line. Similarly, the second scan signal may have a gate-on voltage such that transistors of sub-pixels SP receiving the second scan signal are turned on. In other words, supplying the second scan signal to a sub-gate line may mean that the gate-on voltage is supplied to the corresponding sub-gate line.

The emission driver 126 may receive an emission start signal EFLM. The emission driver 126 may generate an emission control signal while shifting the emission start signal EFLM in response to a clock signal. The emission driver 126 may sequentially supply the emission control signal to emission control lines EL1 to ELm. The emission control signal may have a gate-off voltage such that transistors of sub-pixels SP are turned off. In other words, supplying the emission control signal to an emission control line may mean that the gate-off voltage is supplied to the corresponding emission control line.

The first scan start signal FLM1, the second scan start signal FLM2, and the emission start signal EFLM may be included in the gate control signal GCS of FIG. 1. The gate control signal GCS may further include clock signals provided to the first and second gate drivers 122 and 124 and the emission driver 126.

Each of the sub-pixels SP may include a P-type transistor. For example, each of the sub-pixels SP may include a P-channel metal oxide semiconductor (PMOS) transistor. In this case, the first and second scan signals may have a gate-on voltage of a logic low level and a gate-off voltage of a logic high level, and the emission control signal may have a gate-on voltage of a logic low level and a gate-off voltage of a logic high level.

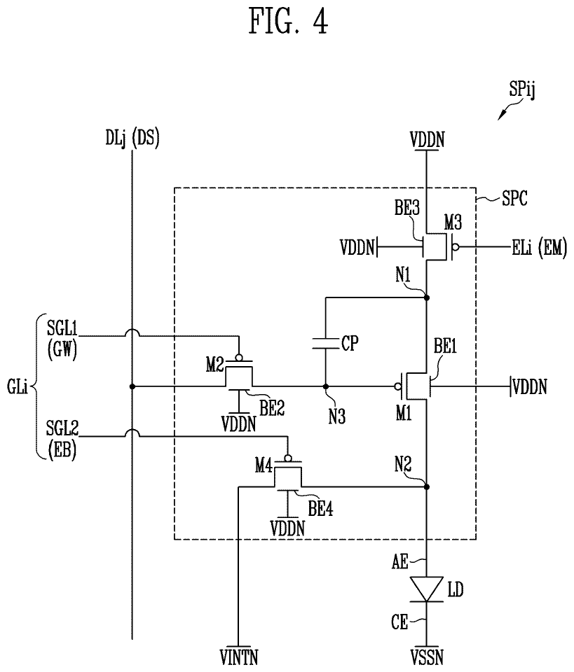

FIG. 4 is a circuit diagram illustrating an embodiment of the sub-pixel of FIG. 2.

Referring to FIG. 4, the sub-pixel SPij may include a sub-pixel circuit SPC and a light emitting element LD.

The light emitting element LD may include an anode electrode AE, a cathode electrode CE, and a light emitting layer. The light emitting layer may be physically disposed between the anode electrode AE and the cathode electrode CE. The anode electrode AE of the light emitting element LD may be electrically connected to the first power source voltage node VDDN via a second node N2, a first transistor M1, a first node N1, and a third transistor M3. The cathode electrode CE of the light emitting element LD may be electrically connected to the second power source voltage node VSSN. The light emitting element LD may generate light with a predetermined luminance according to the amount of current supplied between the first power source voltage node VDDN and the second power source voltage node VSSN via the sub-pixel circuit SPC.

The light emitting element LD may include an organic light emitting diode. However, embodiments of the present invention are not limited thereto. For example, the light emitting element LD may include an inorganic light emitting diode, such as, for example, a micro LED (light emitting diode) or a quantum dot light emitting diode. For example, the light emitting element LD may be an element including both organic and inorganic materials. In FIG. 4, the sub-pixel SPij is illustrated as including one light emitting element LD, but is not limited thereto. For example, the sub-pixel SPij may include two or more light emitting elements. In this case, the two or more light emitting elements may be connected in series or in parallel.

The sub-pixel circuit SPC may include the first transistor M1, a second transistor M2, the third transistor M3, a fourth transistor M4, and a capacitor CP.

The first transistor M1 through the fourth transistor M4 may be P-channel metal oxide semiconductor (PMOS) transistors.

The first transistor M1 may be connected between the first node N1 and the second node N2. A gate electrode of the first transistor M1 may be connected to a third node N3. The first transistor M1 may control the amount of current supplied from the first power source voltage node VDDN to the light emitting element LD and to the second power source voltage node VSSN in response to a voltage of the third node N3.

The second transistor M2 may be connected between the data line DLj and the third node N3. A gate electrode of the second transistor M2 may be connected to the first sub-gate line SGL1 of the gate line GLi. The second transistor M2 may turn on when a first scan signal GW is supplied to the first sub-gate line SGL1 (when the first scan signal GW is at the gate-on voltage of the logic low level) and electrically connect to the data line DLj and the third node N3. In this case, a data signal DS of the data line DLj may be transmitted to the third node N3 via the second transistor M2.

The third transistor M3 may be connected between the first power source voltage node VDDN and the first node N1. A gate electrode of the third transistor M3 may be connected to the emission control line ELi. The third transistor M3 may turn off when the emission control signal EM is supplied to the emission control line ELi (when the emission control signal EM is at the gate-off voltage of the logic high level).

The fourth transistor M4 may be connected between the second node N2 and an initialization voltage node VINTN. A gate electrode of the fourth transistor M4 may be connected to the second sub-gate line SGL2 of the gate line GLi. The fourth transistor M4 may turn on when a second scan signal EB is supplied to the second sub-gate line SGL2 (when the second scan signal EB is at the gate-on voltage of the logic low level) and electrically connect the second node N2 to the initialization voltage node VINTN. The initialization voltage node VINTN may have the initialization voltage. The initialization voltage may be provided by the voltage generator 140 of FIG. 1. In an example in which the fourth transistor M4 is turned on and the initialization voltage is supplied to the anode electrode AE of the light emitting device LD, the light emitting element LD may turn off. The anode electrode AE of the light emitting element LD may be initialized.

The first transistor M1 through the fourth transistor M4 may be implemented based on a silicon substrate. The first transistor M1 through the fourth transistor M4 may be metal oxide semiconductor field effect transistors (MOSFET) including body electrodes BE1 to BE4. A substrate of the display panel 110 may include a semiconductor material such as, for example, silicon, germanium, and/or silicon-germanium suitable for forming the first transistor M1 through the fourth transistor M4. For example, a well may be formed within a silicon substrate through an ion implantation process, and source and drain regions of the well may serve as semiconductor parts of each transistor. In some aspects, a conductive pattern disposed on the substrate may serve as a gate electrode of each transistor. A body electrode of each transistor may be electrically connected to a corresponding well. The first transistor M1 through the fourth transistor M4 implemented based on the silicon substrate may be mounted in a small area. Accordingly, the sub-pixels SP (see FIG. 1) of the display panel 110 may have relatively high resolution.

When the first transistor M1 through the fourth transistor M4 are implemented based on a silicon substrate, biasing the body electrodes BE1 to BE4 of the first transistor M1 through the fourth transistor M4 may ensure operational reliability. In some embodiments, the body electrodes BE1 to BE4 of the first transistor M1 through the fourth transistor M4 may be biased with the first power source voltage VDD (see FIG. 1). For example, the body electrodes BE1 to BE4 of the first transistor M1 through the fourth transistor M4 may be commonly connected to the first power source voltage node VDDN. Accordingly, the body electrodes BE1 to BE4 of the first transistor M1 through the fourth transistor M4 can be efficiently biased.

The capacitor CP may be connected between the first node N1 and the third node N3. The capacitor CP may be driven as a coupling capacitor. For example, the capacitor CP may transfer a voltage change in the third node N3 to the first node N1, or may transfer a voltage change in the first node N1 to the third node N3. The capacitor CP may store the voltage of the third node N3, for example, a voltage of the data signal DS received through the data line DLj and the second transistor M2.

As described herein, the first transistor M1 through the fourth transistor M4 may be mounted in a relatively small area. Accordingly, the sub-pixels SP may have relatively high resolution. In some other sub-pixels, when the number of capacitors included in each sub-pixel is relatively large, the size of each sub-pixel may be relatively large. Accordingly, the resolution of such other sub-pixels may be reduced.

According to an embodiment supported by the present disclosure, in the sub-pixel SPij including the first transistor M1 through the fourth transistor M4 having the body electrodes BE1 to BE4, the sub-pixel SPij may include the capacitor CP connected between the first node N1 and the third node N3, without including a capacitor between the second node N2 and the third the nodes N3. The sub-pixel SPij may include a single capacitor CP connected between the first node N1 and the third node N3 without any other capacitors (e.g., the sub-pixel SPij may be implemented without including any capacitors other than the capacitor CP). Accordingly, the cost (or manufacturing cost) of the display panel 110 and/or the display device 100 can be reduced. In some aspects, the sub-pixels SP may be designed to have increased resolution.

In some embodiments, the capacitor CP may be implemented as a metal-oxide-metal (MOM) capacitor, but is not limited thereto.

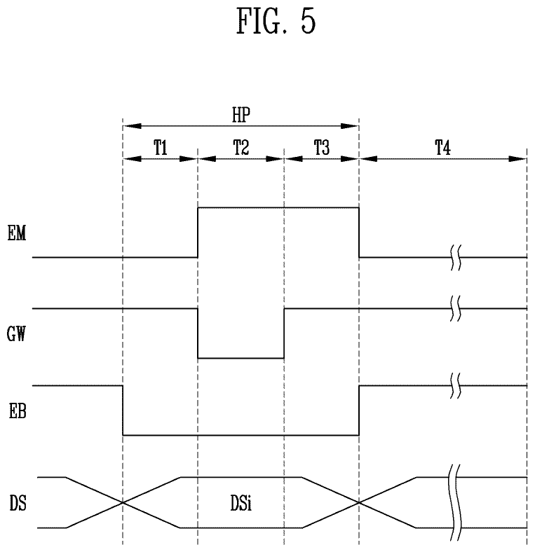

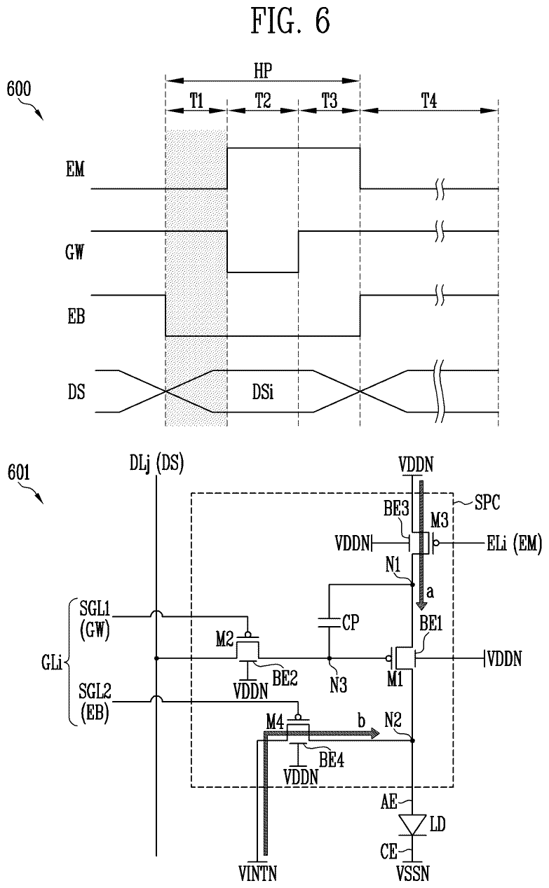

FIG. 5 is a timing diagram illustrating an embodiment of signals provided to the sub-pixel of FIG. 4 during a display operation. FIGS. 6 to 9 are diagrams for explaining operations of the sub-pixel in first to fourth periods of FIG. 5.

First, referring to FIGS. 4 and 5, in a first period T1, the second scan signal EB may be enabled with the gate-on voltage (expressed another way, the second scan signal EB may be at the logic low level). The first scan signal GW may be disabled with a gate-off voltage (expressed another way, the first scan signal GW may be at the logic high level), and the emission control signal EM may be disabled with a gate-on voltage (expressed another way, the emission control signal EM may be at the logic high level).

FIG. 6 illustrates a timing diagram 600 and an operation example 601 of the sub-pixel of FIG. 4. Referring to FIG. 6, in the first period T1, the third transistor M3 may turn on in response to the emission control signal EM. Accordingly, the first power source voltage VDD (see FIG. 1) of the first power source voltage node VDDN may be transmitted to the first node N1 (see a) via the third transistor M3. The fourth transistor M4 may turn on in response to the second scan signal EB. Accordingly, the initialization voltage of the initialization voltage node VINTN may be transmitted to the second node N2 (see b) via the fourth transistor M4. Accordingly, each of the first node N1 and the anode electrode AE of the light emitting element LD may be initialized to a predetermined voltage. As described herein, the first power source voltage VDD may be applied to the body electrodes BE1 to BE4 of the first transistor M1 through the fourth transistor M4. This first period T1 may be referred to as an initialization period.

Referring again to FIGS. 4 and 5, in a second period T2, the first scan signal GW may be enabled with the gate-on voltage (expressed another way, the first scan signal GW may transition to or be at a logic low level). The emission control signal EM may transition to the gate-off voltage (logic high level). In some embodiments, the emission control signal EM may transition to the gate-off voltage after a predetermined time from a time point in which the first scan signal GW transitions to the gate-on voltage. The second scan signal EB may continuously maintain the gate-on voltage.

In the second period T2, data signals corresponding to sub-pixels SP in the i-th row may be applied to the first data line DL1 through n-th data line DLn of FIG. 1. Accordingly, an i-th data signal DSi of FIG. 5 may be applied to the data line DLj of FIG. 4 as the data signal DS.

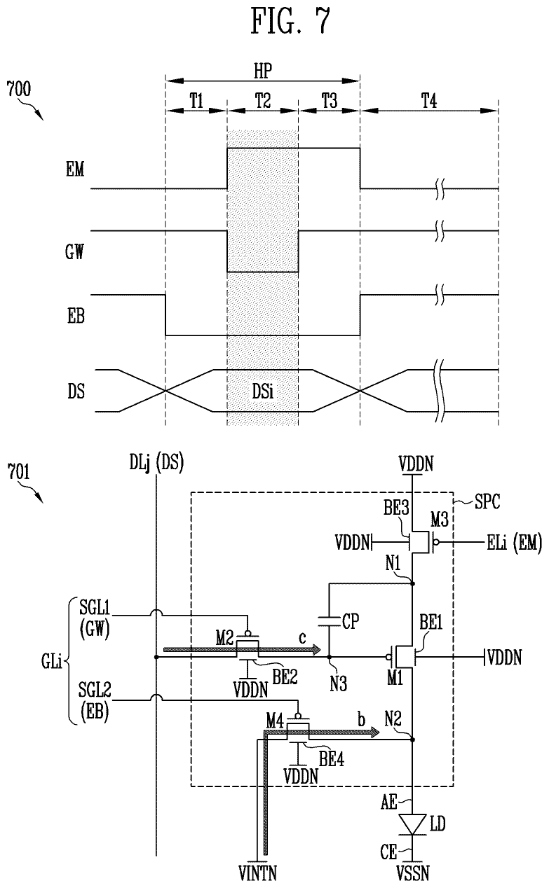

FIG. 7 illustrates a timing diagram 700 and an operation example 701 of the sub-pixel of FIG. 4. Referring to FIG. 7, in the second period T2, the second transistor M2 may turn on in response to the first scan signal GW. Accordingly, the data signal DSi may be supplied to the third node N3 (see c). The third transistor M3 may turn off in response to the emission control signal EM. The second node N2 may continuously remain connected to the initialization voltage node VINTN through the turned-on fourth transistor M4 (see b).

The gate electrode of the first transistor M1 may be connected to the third node N3. The gate electrode of the first transistor M1 may have a voltage of the data signal DSi. The capacitor CP may store the voltage of the data signal DSi. This second period T2 may be referred to as a data writing period.

A source electrode of the first transistor M1 may be connected to the first node N1. A voltage of the first node N1 may be a value obtained by subtracting a threshold voltage of the first transistor M1 from a voltage of the gate electrode of the first transistor M1. In this case, the threshold voltage of the first transistor M1 may be a threshold voltage that reflects the body effect associated with the first transistor M1. For example, a gate-source voltage of the first transistor M1 may be determined according to Equation 1 below.

$$Vgs = V data - ( V data - Vth ) \qquad [ Equation 1 ]$$

In Equation 1, Vdata may represent the voltage of the data signal DSi, Vth may represent the threshold voltage of the first transistor M1, and Vgs may represent the gate-source voltage of the first transistor M1. A gate voltage of the first transistor M1 may be the voltage Vdata of the data signal DSi. A source voltage of the first transistor M1 may be a value obtained by subtracting the threshold voltage Vth of the first transistor M1 from the voltage Vdata of the data signal DSi. According to Equation 1, the gate-source voltage of the first transistor M1 may be the threshold voltage Vth of the first transistor M1.

The threshold voltage Vth of the first transistor M1 may be a threshold voltage that reflects the body effect according to the first power source voltage VDD applied to the body electrode BE1 of the first transistor M1. For example, the threshold voltage Vth of the first transistor M1 may be determined according to Equation 2 below.

$$Vth = Vth 0 + α \times ( ( V data - Vth ) - VDD ) \qquad [ Equation 2 ]$$

In Equation 2, Vth0 may represent an intrinsic threshold voltage of the first transistor M1, and a may be a coefficient associated with the body effect and may be a constant. The coefficient α may be determined by a capacitance of an oxide layer disposed between the gate electrode and a channel of the first transistor M1, a doping concentration of an n-well of the first transistor M1, and the like. VDD may represent the first power source voltage VDD.

As illustrated in Equation 2, the threshold voltage Vth of the first transistor M1 may be determined according to the sum of the intrinsic threshold voltage of the first transistor M1 and the threshold voltage due to the body effect. Here, the intrinsic threshold voltage may be determined according to configurations of the first transistor M1 according to a manufacturing process, for example, a channel width of the first transistor M1 and the like. The threshold voltage due to the body effect may be determined according to a value obtained by subtracting a voltage of the body electrode BE1 of the first transistor M1 from a voltage of the source electrode of the first transistor M1.

As described herein, the source voltage of the first transistor M1 may be a value obtained by subtracting the threshold voltage Vth of the first transistor M1 from the voltage Vdata of the data signal DSi. The voltage of the body electrode BE1 of the first transistor M1 may be the first power source voltage VDD.

According to Equation 2, Vth may be expressed as Equation 3 below.

$$Vth = \frac{Vth 0 + α \times ( V data - VDD )}{1 + α} \qquad [ Equation 3 ]$$

Referring again to FIGS. 4 and 5, in a third period T3, the first scan signal GW may be disabled with the gate-off voltage (expressed another way, the first scan signal GW may transition to or be at logic high level). The second scan signal EB may continuously maintain the gate-on voltage (logic low level), and the emission control signal EM may continuously maintain the gate-off voltage (logic high level).

The first period T1 through the third period T3 may be defined as a horizontal period HP for sub-pixels SP (see FIG. 1) of one row.

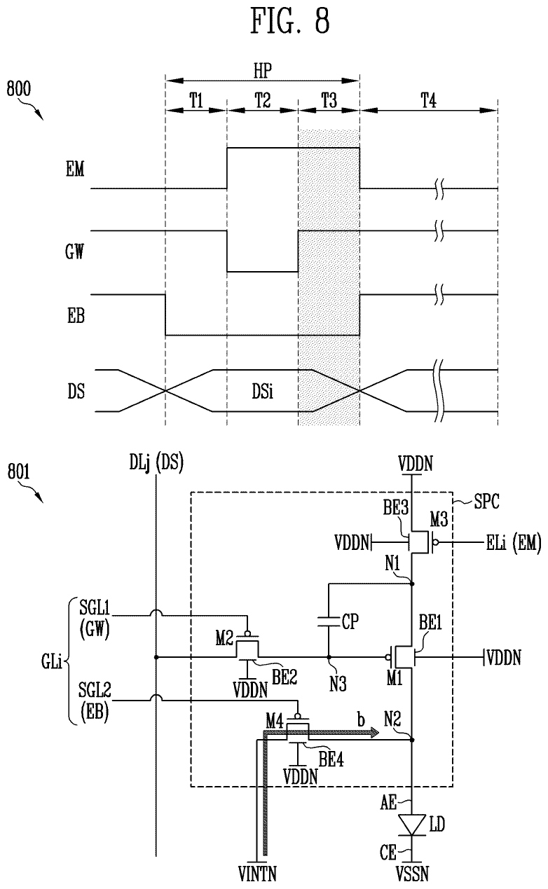

FIG. 8 illustrates a timing diagram 800 and an operation example 801 of the sub-pixel of FIG. 4. Referring to FIG. 8, the second transistor M2 may turn off according to the gate-off voltage (logic high level) of the first scan signal GW. Since the second scan signal EB maintains the gate-on voltage, the fourth transistor M4 may remain in a continuous on-state (i.e., be continuously turned on). The second node N2 may continuously remain electrically connected to the initialization voltage node VINTN (see b). Accordingly, in the third period T3, the second node N2 may be continuously biased with the initialization voltage.

Due to operations in the second period T2, a voltage of the second node N2 may unintentionally increase. Accordingly, unnecessary or unintended current may be supplied to the light emitting element LD. For example, even when the sub-pixel SPij is driven at the lowest grayscale, if the voltage of the second node N2 increases unintentionally, the light emitting element LD may temporarily emit light. In accordance with one or more embodiments of the present disclosure, biasing the second node N2 with the initialization voltage while the second transistor M2 is turned off in the third period T3 may prevent the light emitting element LD from unintentionally emitting light. Accordingly, the grayscale expression of the display device 100 can be improved. This third period T3 may be referred to as a luminance control period.

In other embodiments, the third period T3 may be omitted.

Referring again to FIGS. 4 and 5, in a fourth period T4, the second scan signal EB may be disabled with the gate-off voltage (expressed another way, the second scan signal EB may transition to or be at logic high level). The emission control signal EM may transition to the gate-on voltage.

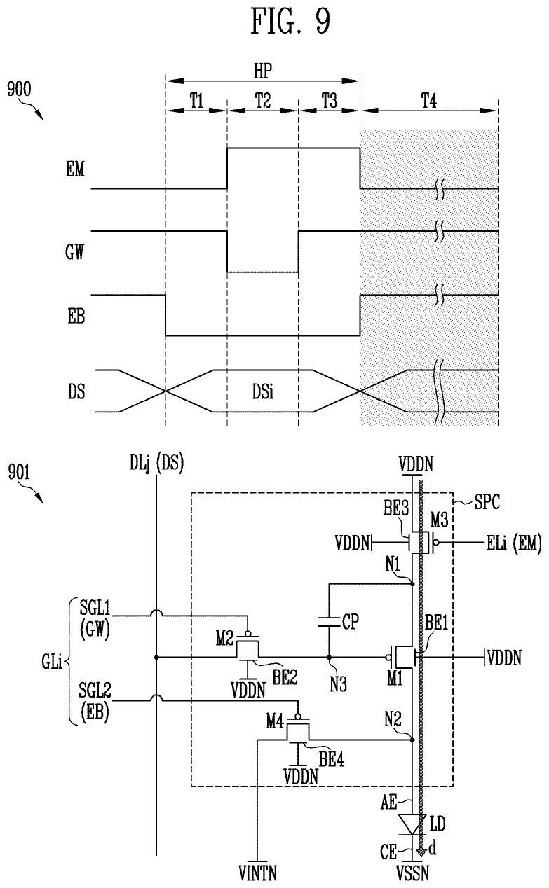

FIG. 9 illustrates a timing diagram 900 and an operation example 901 of the sub-pixel of FIG. 4. Referring to FIG. 9, the fourth transistor M4 may turn off in response to the second scan signal EB. The third transistor M3 may turn on in response to the emission control signal EM. Accordingly, the first transistor M1 may control the amount of current flowing from the first power source voltage node VDDN to the second power source voltage node VDDN via the light emitting element LD in response to the voltage of the third node N3 (see d). During the fourth period T4, the light emitting element LD may generate light with a luminance corresponding to the amount of current flowing through the first transistor M1. This fourth period T4 may be referred to as an emission period.

In some embodiments, in the fourth period T4, the first node N1 may have a voltage level of the first power source voltage VDD. In this case, the body electrode BE1 of the first transistor M1 and the source electrode of the first transistor M1 may be substantially at the same voltage. Accordingly, the body effect of the first transistor M1 may be eliminated. Due to the capacitance of the capacitor CP, the capacitor CP may maintain the gate-source voltage of the first transistor M1 stored as a difference between voltages at both ends of the capacitor CP. For example, the gate-source voltage of the first transistor M1 in the fourth period T4 may be Vth in Equation 3. Equation 3 may be expressed as Equation 4 below.

$${Vgs}^{′} = \frac{Vth 0}{1 + α} + \frac{α \times ( V data - VDD )}{1 + α} \qquad [ Equation 4 ]$$

In Equation 4, Vgs' may represent the gate-source voltage of the first transistor M1 in the fourth period T4.

According to the gate-source voltage Vgs' of the first transistor M1, the first transistor M1 may determine or control the amount of current flowing from the first power source voltage node VDDN to the second power source voltage node VDDN via the light emitting element LD. Referring to Equation 4, the gate-source voltage Vgs' of the first transistor M1 may change depending on the voltage Vdata of the data signal DSi. For example, the gate-source voltage Vgs' of the first transistor M1 may increase as the voltage Vdata of the data signal DSi increases. The gate-source voltage Vgs' of the first transistor M1 may decrease as the voltage Vdata of the data signal DSi decreases. In this way, the light emitting element LD may emit light such that the amount of emitted light changes depending on the voltage Vdata of the data signal DSi.

Referring to Equation 4, the voltage Vdata of the data signal DSi may be reflected in the gate-source voltage Vgs' of the first transistor M1 according to

$$\frac{α}{1 + α} .$$

Accordingly, compared to the variation in the voltage Vdata of the data signal DSi, the variation in the gate-source voltage Vgs' of the first transistor M1 may be relatively small. Considering that an allowable range of voltages applied to electrodes of the first transistor M1 may be limited, as the coefficient α decreases, an allowable swing width of the voltage Vdata of the data signal DSi may increase. Accordingly, in accordance with Equation 4, a range of the voltage Vdata of the data signal DSi can be expanded. Accordingly, for example, the voltage Vdata of the data signal DSi has improved reliability in expressing each grayscale.

The intrinsic threshold voltage Vth0 of the first transistor M1 may be reflected in the gate-source voltage Vgs' of the first transistor M1 according to the ratio of a/1+a. Compared to the error (for example, process error) in the intrinsic threshold voltage Vth0 of the first transistor M1, the variation in the gate-source voltage Vgs' of the first transistor M1 may be relatively small. Accordingly, the light emitting element LD may be driven with relatively high reliability according to the data signal DSi.

First transistors of the sub-pixels SP of FIG. 1 may have different intrinsic threshold voltages due to errors during a manufacturing process, stress due to driving, and the like. In other words, the intrinsic threshold voltages of the first transistors of the sub-pixels SP may have a specific distribution. For example, if the error in the intrinsic threshold voltage Vth0 of the first transistor M1 of each sub-pixel becomes larger, the distribution of the intrinsic threshold voltage may become wider. In this case, mura may unintentionally appear in an image displayed by the sub-pixels SP. The controller 150 of FIG. 1 may employ at least one of various algorithms for compensating for mura in an image. A mura compensation algorithm of the controller 150 may process the input image data IMG or the image data DATA through various methods and provide the processed data to the data driver 130. The data driver 130 may drive the sub-pixels SP according to the processed data. Accordingly, the sub-pixels SP may be driven with higher reliability according to data signals.

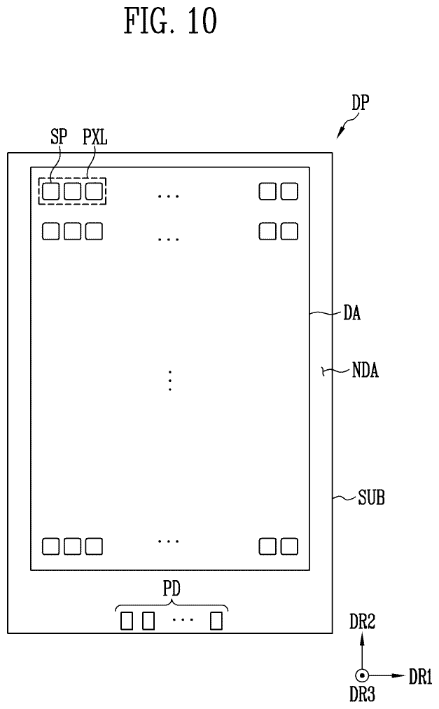

FIG. 10 is a plan view illustrating an embodiment of the display panel of FIG. 1.

Referring to FIG. 10, one embodiment DP of the display panel 110 of FIG. 1 may include a display area DA and a non-display area NDA. The display panel DP may display an image through the display area DA. The non-display area NDA may be disposed around the display area DA.

The display panel DP may include a substrate SUB, sub-pixels SP, and pads PD.

When the display panel DP is used as a display screen for a head-mounted display (HMD) device, a virtual reality (VR) device, a mixed reality (MR) device, an augmented reality (AR) device, or the like, the display panel DP may be positioned very close to the user's eyes. In this case, sub-pixels SP with relatively high integration may be required. In order to increase the integration of the sub-pixels SP, the substrate SUB may be provided as a silicon substrate. The sub-pixels SP may be formed on the substrate SUB, which is a silicon substrate. The display device 100 (see FIG. 1) including the display panel DP formed on the substrate SUB, which is a silicon substrate, may be referred to as an OLED on Silicon (OLEDOS) display device.

The sub-pixels SP may be disposed in the display area DA on the substrate SUB. The sub-pixels SP may be arranged in a matrix form along a first direction DR1 and a second direction DR2 intersecting the first direction DR1. However, embodiments of the present invention are not limited thereto. For example, the sub-pixels SP may be arranged in a zigzag shape along the first direction DR1 and the second direction DR2. The first direction DR1 may be a row direction, and the second direction DR2 may be a column direction.

Two or more sub-pixels among a plurality of sub-pixels SP may constitute one pixel PXL.

Components for controlling the sub-pixels SP may be disposed in the non-display area NDA on the substrate SUB. For example, wirings such as, for example, the first gate line GL1 through the m-th gate line GLm of FIG. 1, the first emission control line EL1 through m-th emission control line ELm of FIG. 1, and the first data line DL1 through n-th data line DLn of FIG. 1 may be disposed in the non-display area NDA.

At least one of the gate driver 120, the data driver 130, the voltage generator 140, and the controller 150 of FIG. 1 may be integrated in the non-display area NDA of the display panel DP. In some embodiments, the gate driver 120 of FIG. 1 may be mounted on the display panel DP and disposed in the non-display area NDA. In other embodiments, the gate driver 120 may be implemented as an integrated circuit separate from the display panel DP.

The pads PD may be disposed in the non-display area NDA on the substrate SUB. The pads PD may be electrically connected to the sub-pixels SP through wirings. For example, the pads PD may be connected to the sub-pixels SP through the first data line DL1 through n-th data line DLn.

The pads PD may interface the display panel DP to other components of the display device 100 (see FIG. 1). In some embodiments, voltages and signals supportive of the operation of components included in the display panel DP may be provided from the driver integrated circuit DIC of FIG. 1 through the pads PD. For example, the first data line DL1 through n-th data line DLn may be connected to the driver integrated circuit DIC through the pads PD. For example, the first and second power source voltages VDD and VSS may be received from the driver integrated circuit DIC through the pads PD. In an example in which the gate driver 120 is mounted on the display panel DP, the gate control signal GCS may be transmitted from the driver integrated circuit DIC to the gate driver 120 through the pads PD.

In some embodiments, a circuit board may be electrically connected to the pads PD using a conductive adhesive member such as, for example, an anisotropic conductive film. In this case, the circuit board may be a flexible circuit board (FPCB) or a flexible film formed of a flexible material. The driver integrated circuit DIC may be mounted on the circuit board and electrically connected to the pads PD.

In some embodiments, the display area DA may have various shapes. The display area DA may have a closed loop shape including straight and/or curved sides. For example, the display area DA may have a shape such as, for example, a polygon, circle, semicircle, or ellipse.

In some embodiments, the display panel DP may have a flat display surface. In other embodiments, the display panel DP may have a display surface that is at least partially round. In some embodiments, the display panel DP may be bent, folded, or rolled. In these cases, the display panel DP and/or the substrate SUB may include a material having flexible properties.

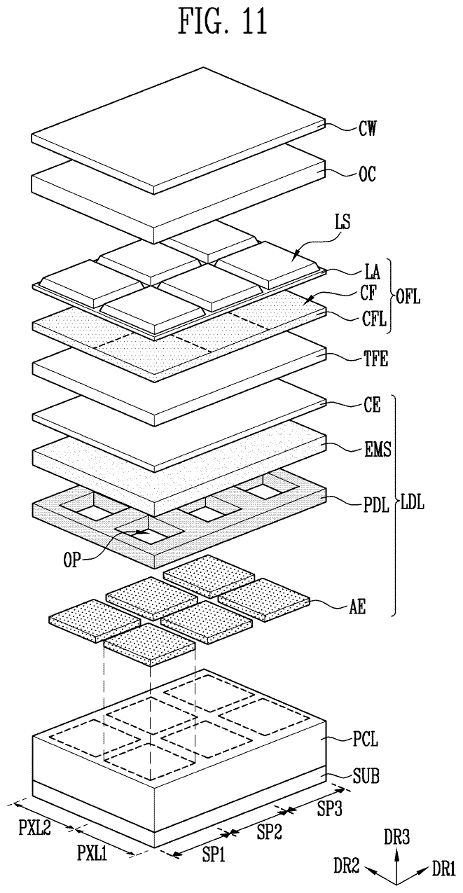

FIG. 11 is an exploded perspective view illustrating a portion of the display panel of FIG. 10. In FIG. 11, for clear and concise description, a portion of the display panel DP corresponding to two pixels PXL1 and PXL2 among the pixels PXL of FIG. 10 is schematically illustrated. Other portions of the display panel DP corresponding to the remaining pixels may be configured similarly.

Referring to FIGS. 10 and 11, each of first and second pixels PXL1 and PXL2 may include first sub-pixel SP1, second sub-pixel SP2, and third sub-pixel SP3. However, embodiments of the present invention are not limited thereto. For example, each of the first and second pixels PXL1 and PXL2 may include four sub-pixels or two sub-pixels.

In FIG. 11, the first sub-pixel SP1, the second sub-pixel SP2, and the third sub-pixel SP3 are illustrated as having rectangular shapes and having the same sizes when viewed from a third direction DR3 intersecting the first and second directions DR1 and DR2. However, embodiments of the present invention are not limited thereto. The first sub-pixel SP1, the second sub-pixel SP2, and the third sub-pixel SP3 may be modified to have various shapes.

The display panel DP may include a substrate SUB, a pixel circuit layer PCL, a light emitting element layer LDL, an encapsulation layer TFE, an optical functional layer OFL, an overcoat layer OC, and a cover window CW.

In some embodiments, the substrate SUB may include a silicon wafer substrate formed using a semiconductor process. The substrate SUB may include a semiconductor material suitable for forming circuit elements. For example, the semiconductor material may include silicon, germanium, and/or silicon-germanium. The substrate SUB may be provided from a bulk wafer, an epitaxial layer, a silicon on insulator (SOI) layer, or a semiconductor on insulator (SeOI) layer.

The pixel circuit layer PCL may be disposed on the substrate SUB. The substrate SUB and/or the pixel circuit layer PCL may include insulating layers and conductive patterns disposed between the insulating layers. The conductive patterns of the pixel circuit layer PCL may function as at least some of circuit elements, wirings, and the like. The conductive patterns may include copper, but embodiments of the present invention are not limited thereto.

The circuit elements may include a sub-pixel circuit SPC (see FIG. 2) for each of the first sub-pixel SP1, the second sub-pixel SP2, and the third sub-pixel SP3. The sub-pixel circuit SPC may include the first transistor M1 through the fourth transistor M4 and the capacitor CP of FIG. 4. Each transistor may include a semiconductor portion including a source region, a drain region, and a channel region, and a gate electrode overlapping the semiconductor portion. In some embodiments, when the substrate SUB is provided as a silicon substrate, the semiconductor portion may be included within the substrate SUB, and the gate electrode may be included within the pixel circuit layer PCL as a conductive pattern of the pixel circuit layer PCL. A body electrode of each transistor may be further provided on the bottom of the substrate SUB or in an area adjacent to the bottom of the substrate SUB. The capacitor CP may include electrodes spaced apart from each other. For example, the capacitor CP may include electrodes spaced apart from each other on a plane defined by the first and second directions DR1 and DR2. For example, the capacitor CP may include electrodes spaced apart from each other in the third direction DR3 with an insulating layer interposed between the electrodes. If the sub-pixel circuit SPC does not include any capacitors other than the capacitor CP, an area occupied by the sub-pixel circuit SPC can be reduced, and the cost (or manufacturing cost) for the sub-pixel circuit SPC can be reduced.

Wirings of the pixel circuit layer PCL may include signal lines connected to each of the first sub-pixel SP1, the second sub-pixel SP2, and the third sub-pixel SP3, for example, a gate line, an emission control line, and a data line. The wirings may further include a wiring connected to the first power source voltage node VDDN of FIG. 2. In some aspects, the wirings may further include a wiring connected to the second power source voltage node VSSN of FIG. 2.

The light emitting element layer LDL may include anode electrodes AE, a pixel defining layer PDL, a light emitting structure EMS, and a cathode electrode CE.

The anode electrodes AE may be disposed on the pixel circuit layer PCL. The anode electrodes AE may contact circuit elements of the pixel circuit layer PCL. The anode electrodes AE may include an opaque conductive material that can reflect light, but embodiments of the present invention are not limited thereto.

The pixel defining layer PDL may be disposed on the anode electrodes AE. The pixel defining layer PDL may include an opening OP exposing a portion of each of the anode electrodes AE. The opening OP of the pixel defining layer PDL may be understood as an emission area corresponding to each of the first sub-pixel SP1, the second sub-pixel SP2, and the third sub-pixel SP3.

In some embodiments, the pixel defining layer PDL may include an inorganic material. In this case, the pixel defining layer PDL may include a plurality of stacked inorganic layers. For example, the pixel defining layer PDL may include silicon oxide (SiOx) and silicon nitride (SiNx). In other embodiments, the pixel defining layer PDL may include an organic material. However, the material of the pixel defining layer PDL is not limited thereto.

The light emitting structure EMS may be disposed on each of the anode electrodes AE exposed by the opening OP of the pixel defining layer PDL. The light emitting structure EMS may include a light emitting layer configured to generate light, an electron transport layer configured to transport electrons, a hole transport layer configured to transport holes, and the like.

In some embodiments, the light emitting structure EMS may fill the opening OP of the pixel defining layer PDL, but may be disposed entirely on top of the pixel defining layer PDL. In other words, the light emitting structure EMS may extend across the first sub-pixel SP1, the second sub-pixel SP2, and the third sub-pixel SP3. In this case, at least some of layers of the light emitting structure EMS may be broken or bent at boundaries between the first sub-pixel SP1, the second sub-pixel SP2, and the third sub-pixel SP3. For example, trenches may be disposed in the pixel defining layer PDL, and the light emitting structure EMS may be broken or bent at the boundaries between the first sub-pixel SP1, the second sub-pixel SP2, and the third sub-pixel SP3 due to the trenches. However, embodiments of the present invention are not limited thereto. For example, portions of the light emitting structure EMS corresponding to the first sub-pixel SP1, the second sub-pixel SP2, and the third sub-pixel SP3 may be separated and spaced apart from each other, and each of them may be disposed within the opening OP of the pixel defining layer PDL.

The cathode electrode CE may be disposed on the light emitting structure EMS. The cathode electrode CE may extend across the first sub-pixel SP1, the second sub-pixel SP2, and the third sub-pixel SP3. In this way, the cathode electrode CE may serve as a common electrode for the first sub-pixel SP1, the second sub-pixel SP2, and the third sub-pixel SP3.

The cathode electrode CE may be a thin metal layer having a thickness sufficient to transmit light emitted from the light emitting structure EMS. The cathode electrode CE may be formed of a metal material or a transparent conductive material to have a relatively thin thickness. In some embodiments, the cathode electrode CE may include at least one of various transparent conductive materials including indium tin oxide, indium zinc oxide, indium tin zinc oxide, aluminum zinc oxide, gallium zinc oxide, zinc tin oxide, or gallium tin oxide. In other embodiments, the cathode electrode CE may include at least one of silver (Ag), magnesium (Mg), and mixtures thereof. However, the material of the cathode electrode CE is not limited thereto.

Any one of the anode electrodes AE, a portion of the light emitting structure EMS overlapping the anode electrode AE, and a portion of the cathode electrode CE overlapping the anode electrode AE may be understood as constituting one light emitting element LD (see FIG. 2). In other words, each of light emitting elements of the first sub-pixel SP1, the second sub-pixel SP2, and the third sub-pixel SP3 may include one anode electrode, a portion of the light emitting structure EMS overlapping the anode electrode, and a portion of the cathode electrode CE overlapping the anode electrode. In each of the first sub-pixel SP1, the second sub-pixel SP2, and the third sub-pixel SP3, holes injected from the anode electrode AE and electrons injected from the cathode electrode CE may be transported into the light emitting layer of the light emitting structure EMS to form excitons, and light may be generated when the excitons transition from an excited state to a ground state. The luminance of the light can be determined depending on the amount of current flowing through the light emitting layer. Depending on the configuration of the light emitting layer, the wavelength range of the generated light may be determined.

The encapsulation layer TFE may be disposed on the cathode electrode CE. The encapsulation layer TFE may cover the light emitting element layer LDL and/or the pixel circuit layer PCL. The encapsulation layer TFE may be configured to prevent oxygen and/or moisture from penetrating into the light emitting element layer LDL. In some embodiments, the encapsulation layer TFE may include a structure in which one or more inorganic layers and one or more organic layers are alternately stacked. For example, the inorganic layer may include silicon nitride, silicon oxide, or silicon oxynitride (SiOxNy). For example, the organic layer may include an organic insulating material such as, for example, an acrylic resin, an epoxy resin, a phenol resin, a polyamide resin, a polyimide resin, an unsaturated polyester resin, a polyphenylenether resin, a polyphenylenesulfide resin, or benzocyclobutene (BCB). However, materials of the organic and inorganic layers of the encapsulation layer TFE are not limited thereto.

To improve the encapsulation effect of the encapsulation layer TFE, the encapsulation layer TFE may further include a thin film including aluminum oxide (AIOx). The thin film including aluminum oxide may be positioned on an upper surface of the encapsulation layer TFE facing the optical functional layer OFL and/or on a lower surface of the encapsulating layer TFE facing the light emitting element layer LDL.

The thin film including aluminum oxide may be formed through an atomic layer deposition (ALD) method. However, embodiments of the present invention are not limited thereto. The encapsulation layer TFE may further include a thin film formed of at least one of various materials suitable for improving the encapsulation effect.

The optical functional layer OFL may be disposed on the encapsulation layer TFE. The optical functional layer OFL may include a color filter layer CFL and a lens array LA.

The color filter layer CFL may be disposed between the encapsulation layer TFE and the lens array LA. The color filter layer CFL may be configured to filter light emitted from the light emitting structure EMS and selectively output light in a wavelength range or color corresponding to each sub-pixel. The color filter layer CFL may include color filters CF corresponding to the first sub-pixel SP1, the second sub-pixel SP2, and the third sub-pixel SP3. Each of the color filters CF may pass through light in a wavelength range corresponding to a corresponding sub-pixel. For example, a color filter corresponding to the first sub-pixel SP1 may passe red light, a color filter corresponding to the second sub-pixel SP2 may passe green light, and a color filter corresponding to the third sub-pixel SP3 may pass blue light. Depending on the light emitted from the light emitting structure EMS of each sub-pixel, at least some of the color filters CF may be omitted.

The lens array LA may be disposed on the color filter layer CFL. The lens array LA may include lenses LS corresponding to the first sub-pixel SP1, the second sub-pixel SP2, and the third sub-pixel SP3. Each of the lenses LS may improve light output efficiency by outputting the light emitted from the light emitting structure EMS through an intended path. The lens array LA may have a relatively high refractive index. For example, the lens array LA may have a higher refractive index than the overcoat layer OC. In some embodiments, the lenses LS may include an organic material. In some embodiments, the lenses LS may include an acrylic material. However, the material of the lenses LS is not limited thereto.

The overcoat layer OC may be disposed on the lens array LA. The overcoat layer OC may cover the optical functional layer OFL, the encapsulation layer TFE, the light emitting structure EMS, and/or the pixel circuit layer PCL. The overcoat layer OC may include various materials suitable for protecting its underlying layers from foreign substances such as, for example, dust, moisture, or the like. For example, the overcoat layer OC may include at least one of an inorganic insulating layer and an organic insulating layer. For example, the overcoat layer OC may include epoxy, but embodiments of the present invention are not limited thereto. The overcoat layer OC may have a lower refractive index than the lens array LA.

The cover window CW may be disposed on the overcoat layer OC. The cover window CW may be configured to protect its underlying layers. The cover window CW may have a higher refractive index than the overcoat layer OC. The cover window CW may include glass, but embodiments of the present invention are not limited thereto. For example, the cover window CW may be an encapsulation glass configured to protect components disposed thereunder. In other embodiments, the cover window CW may be omitted.

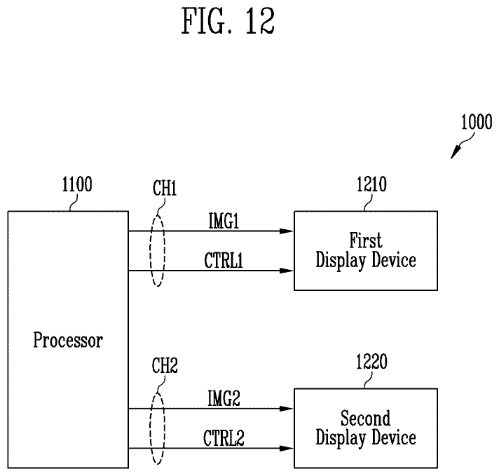

FIG. 12 is a block diagram illustrating an embodiment of a display system.

Referring to FIG. 12, a display system 1000 may include a processor 1100 and one or more display devices 1210 and 1220.

The processor 1100 may perform various tasks and calculations. In some embodiments, the processor 1100 may include an application processor, a graphics processor, a microprocessor, a central processing unit (CPU), and the like. The processor 1100 may be connected to and control other components of the display system 1000 through a bus system.

In FIG. 12, the display system 1000 is illustrated as including first and second display devices 1210 and 1220. The processor 1100 may be connected to the first display device 1210 through a first channel CH1 and to the second display device 1220 through a second channel CH2.

Through the first channel CH1, the processor 1100 may transmit first image data IMG1 and a first control signal CTRL1 to the first display device 1210. The first display device 1210 may display an image based on the first image data IMG1 and the first control signal CTRL1. The first display device 1210 may be configured similarly to the display device 100 described with reference to FIG. 1. In this case, the first image data IMG1 and the first control signal CTRL1 may be provided as the input image data IMG and the control signal CTRL of FIG. 1, respectively.

Through the second channel CH2, the processor 1100 may transmit second image data IMG2 and a second control signal CTRL2 to the second display device 1220. The second display device 1220 may display an image based on the second image data IMG2 and the second control signal CTRL2. The second display device 1220 may be configured similarly to the display device 100 described with reference to FIG. 1. In this case, the second image data IMG2 and the second control signal CTRL2 may be provided as the input image data IMG and the control signal CTRL of FIG. 1, respectively.

As described herein, each of the sub-pixels SP of the display device 100 of FIG. 1 may include a single capacitor CP connected between the first and third nodes N1 and N3 of FIG. 4 without any other capacitors (e.g., each of the sub-pixels SP may be implemented without including any other capacitors other than the capacitor CP). Accordingly, the display system 1000 can be designed to include sub-pixels SP with increased resolution. In some aspects, the cost (or manufacturing cost) of the display system 1000 can be reduced.

The display system 1000 may include a computing system that provides an image display function, such as, for example, a portable computer, a mobile phone, a smart phone, a tablet personal computer, a smart watch, a watch phone, a portable multimedia player (PMP), a navigation, and an ultra mobile personal computer (UMPC). In some aspects, the display system 1000 may include at least one of a head-mounted display (HMD) device, a virtual reality (VR) device, a mixed reality (MR) device, and an augmented reality (AR) device.

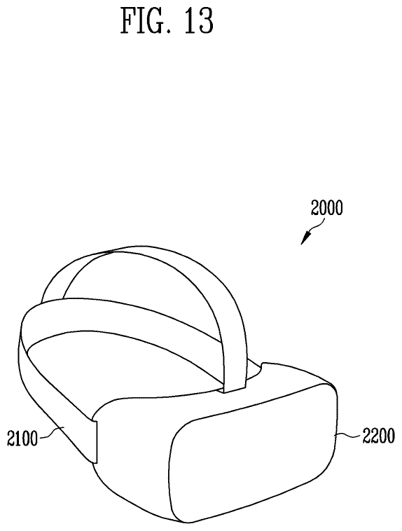

FIG. 13 is a perspective view illustrating an application example of the display system of FIG. 12.

Referring to FIG. 13, the display system 1000 of FIG. 12 may be applied to a head-mounted display device 2000. The head-mounted display device 2000 may be a wearable electronic device that can be worn on a user's head.

The head-mounted display device 2000 may include a head mounting band 2100 and a display device storage case 2200. The head mounting band 2100 may be connected to the display device storage case 2200. The head mounting band 2100 may include a horizontal band and/or a vertical band for fixing the head-mounted display device 2000 to the user's head. The horizontal band may be configured to surround the side of the user's head, and the vertical band may be configured to surround the top of the user's head. However, embodiments of the present invention are not limited thereto. For example, the head mounting band 2100 may be implemented in the form of glasses frames, helmets, or the like.

The display device storage case 2200 may accommodate the first and second display devices 1210 and 1220 of FIG. 12. The display device storage case 2200 may further accommodate the processor 1100 of FIG. 12.

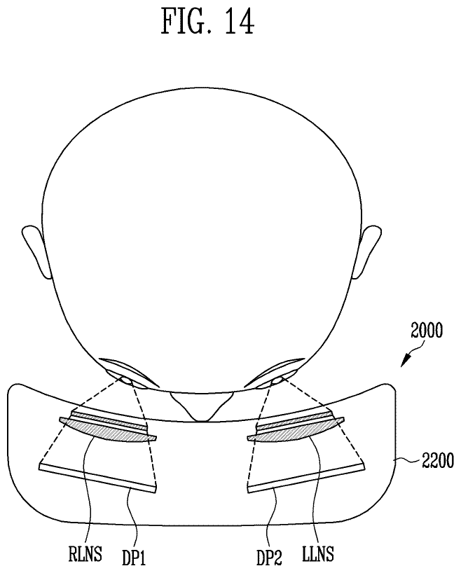

FIG. 14 is a diagram illustrating a head-mounted display device worn by a user of FIG. 13.

Referring to FIG. 14, within the head-mounted display device 2000, a first display panel DP1 of the first display device 1210 and a second display panel DP2 of the second display device 1220 may be disposed. The head-mounted display device 2000 may further include one or more lenses LLNS and RLNS.

Within the display device storage case 2200, a right eye lens RLNS may be disposed between the first display panel DP1 and the user's right eye. Within the display device storage case 2200, a left eye lens LLNS may be disposed between the second display panel DP2 and the user's left eye.

An image output from the first display panel DP1 may be displayed to the user's right eye through the right eye lens RLNS. The right eye lens RLNS may refract light from the first display panel DP1 to be directed toward the user's right eye. The right eye lens RLNS may perform an optical function to adjust the viewing distance between the first display panel DP1 and the user's right eye.

An image output from the second display panel DP2 may be displayed to the user's left eye through the left eye lens LLNS. The left eye lens LLNS may refract light from the second display panel DP2 to be directed toward the user's left eye. The left eye lens LLNS may perform an optical function to adjust the viewing distance between the second display panel DP2 and the user's left eye.

In some embodiments, each of the right eye lens RLNS and the left eye lens LLNS may include an optical lens having a pancake-shaped cross section. In some embodiments, each of the right eye lens RLNS and the left eye lens LLNS may include a multi-channel lens including sub-regions with different optical properties. In this case, each display panel may output images corresponding to the sub-regions of the multi-channel lens, and the output images may pass through corresponding sub-regions and may be displayed to the user.

Effects according to the embodiments of the present invention are not limited to those described herein, and various other effects are included in the present specification.

Although specific embodiments and applications have been described herein, other embodiments and variations may be derived from the above description. Accordingly, the spirit of the invention is not limited to the example embodiments, but extends to the scope of the claims set forth below, various obvious modifications, and equivalents.

What is claimed is:

1. A sub-pixel included in a display device comprising:
a first transistor connected between a first node and a second node and comprising a gate electrode connected to a third node;
a second transistor connected between a data line and the third node and comprising a gate electrode connected to a first sub-gate line;
a third transistor connected between the first node and a first power source voltage node configured to supply a first power source voltage and comprising a gate electrode connected to an emission control line; and
a light emitting element connected between the second node and a second power source voltage node configured to supply a second power source voltage lower than the first power source voltage,
wherein body electrodes of the first transistor through the third transistor are biased with at least one voltage, and
wherein the sub-pixel further comprises a capacitor connected between the first node and the third node, without a capacitor connected to the second node and the third node.

2. The sub-pixel of claim 1, wherein the first power source voltage is applied to the body electrode of the first transistor.

3. The sub-pixel of claim 1, wherein the sub-pixel does not comprise any capacitors other than the capacitor.

4. The sub-pixel of claim 1, further comprising:
a fourth transistor connected between the second node and an initialization voltage node configured to supply an initialization voltage and comprising a gate electrode connected to a second sub-gate line.

5. The sub-pixel of claim 4, wherein the first power source voltage is commonly applied to the body electrodes of the first transistor through the third transistor and a body electrode of the fourth transistor.

6. The sub-pixel of claim 4, wherein each of the first transistor through the fourth transistor is a PMOS (P-channel Metal Oxide Semiconductor) transistor.

7. The sub-pixel of claim 4, wherein the first transistor through the fourth transistor are mounted on a silicon substrate.

8. A display device comprising:
sub-pixels connected to gate lines and emission control lines; and
a gate driver configured to control the gate lines and the emission control lines,
wherein a sub-pixel of the sub-pixels comprises:
a first transistor connected between a first node and a second node and comprising a gate electrode connected to a third node;
a second transistor connected between a data line and the third node and comprising a gate electrode connected to a first sub-gate line of one of the gate lines;
a third transistor connected between the first node and a first power source voltage node configured to supply a first power source voltage and comprising a gate electrode connected to one of the emission control lines; and
a light emitting element connected between the second node and a second power source voltage node configured to supply a second power source voltage lower than the first power source voltage,
wherein body electrodes of the first transistor through the third transistor are biased with at least one voltage, and
wherein the sub-pixel further comprises a capacitor connected between the first node and the third node, without a capacitor connected to the second node and the third node.

9. The display device of claim 8, wherein the first power source voltage is applied to the body electrode of the first transistor.

10. The display device of claim 8, wherein the sub-pixel does not comprise any capacitors other than the capacitor.

11. The display device of claim 8, wherein the sub-pixel further comprises a fourth transistor connected between the second node and an initialization voltage node configured to supply an initialization voltage and comprising a gate electrode connected to a second sub-gate line of the one of the gate lines.

12. The display device of claim 11, wherein the first power source voltage is commonly applied to the body electrodes of the first transistor through the third transistor and a body electrode of the fourth transistor.

13. The display device of claim 11, wherein the gate driver is configured to:
turn on the fourth transistor by supplying a second scan signal set to logic low level to the second sub-gate line during a first period, a second period, and a third period provided sequentially,
turn on the second transistor by supplying a first scan signal set to logic low level to the first sub-gate line and to turn off the third transistor by supplying an emission control signal set to logic high level to the one of the emission control lines, during the second period,
turn off the second transistor by setting the first scan signal to logic high level during the third period, and
turn off the fourth transistor by setting the second scan signal to logic high level and turn on the third transistor by setting the emission control signal to logic low level, during a fourth period.

14. The display device of claim 13, further comprising:
a data driver configured to control the data line,
wherein the data driver is configured to supply a data signal to the data line during the second period.

15. The display device of claim 14, wherein during the second period, the data signal of the data line is reflected in a voltage of the third node through the second transistor, and
wherein during the fourth period, current is supplied from the first power source voltage node to the light emitting element through the third transistor and the first transistor according to the voltage of the third node.

16. A display system comprising:
a processor; and
at least one display device to display images on sub-pixels based on image data from the processor,
wherein one of the sub-pixels comprises:
a first transistor connected between a first node and a second node and comprising a gate electrode connected to a third node;
a second transistor connected between a data line and the third node and comprising a gate electrode connected to a first sub-gate line;
a third transistor connected between the first node and a first power source voltage node configured to supply a first power source voltage and comprising a gate electrode connected to an emission control line; and
a light emitting element connected between the second node and a second power source voltage node configured to supply a second power source voltage lower than the first power source voltage,
wherein body electrodes of the first transistor through the third transistor are biased with at least one voltage, and
wherein the one of the sub-pixels further comprises a capacitor connected between the first node and the third node, without a capacitor connected to the second node and the third node.
